(19) United States
(12) Patent Application Publication
(10) Pub. No.: US 2024/0362496 A1
(43) Pub. Date: Oct. 31, 2024

(54) Computer-Implemented Method and System for Operating a Technical Device

(71) Applicant: Siemens Aktiengesellschaft, Muenchen (DE)

(72) Inventors: Safoura REZAPOUR LAKANI, Wien (AT); Thomas BLUMAUER-HIEßL, Wien (AT); Jana EDER, Wien (AT); Daniel SCHALL, Hollabrunn (AT)

(21) Appl. No.: 18/641,572

(22) Filed: Apr. 22, 2024

(30) Foreign Application Priority Data
Apr. 25, 2023 (EP) 23169732

(51) Int. Cl. G06N 3/098

(52) U.S. Cl. CPC G06N 3/098

(57) ABSTRACT

A computer-implemented method for operating a technical device using a model based on artificial intelligence by a client of a client-server system, wherein each client stores a client model for operating a technical device, where a global model is provided to a client based on federated learning, and where the technical device is operated using the client model and sensitive parameter.

### BACKGROUND OF THE INVENTION

### 1. Field of the Invention

The invention relates to a computer program product, a computer-implemented method and a system for operating a technical device using a model for operating the technical device based on the artificial intelligence by a client of a client-server system having a server, which provides a global model based on federated learning, and at least two clients, where each client has a processor and a memory, and each client stores a client model for operating a connected technical device

### 2. Description of the Related Art

Machine learning (ML) is widely established in industrial applications, such as quality control or the detection of anomalies, in particular in visual quality inspection via electrooptical sensors or image sensors.

In an industrial environment, there are scenarios in which several production sites possibly require the same ML application, such as to detect anomalies of similar products. In this context, the training of an individual model based on collected data from a plurality of products from different production plants or inspection systems leads to an improved ML model overall.

However, the forwarding of data is possibly not practicable on account of data protection concerns or the volume of data. For this reason, a technique known as “federated learning” (FL) can be used to aggregate knowledge between multiple clients and to train a model between said clients without exchanging data.

Data distribution between the clients can be different, i.e., there may be differences in the data collected on each production line. Each client can therefore contain data that is not independent and identically distributed (non-IID). Subsequently, the aggregated FL model may possibly not advantageously be of benefit to all of the clients. Some clients can therefore learn better if they use their own data.

In the prior art, cohort-based federated learning is employed in which the server groups similar clients into cohorts in accordance with their data distribution. Subsequently, an FL model is trained for each cohort. The cohorts are used to build cohorts while taking into account privacy and additional computing complexity and communication costs before starting the federated learning process.

Personalized federated learning is also employed in the prior art, where each client is enabled to use a personalized model instead of a collective global model. The clients can benefit from the global model and at the same time there exists the option to retain their own models and to keep communication at a low level or to reduce it.

### SUMMARY OF THE INVENTION

In view of the foregoing, it is therefore an object of the invention to provide a method via which individual learning in the context of a federated learning process is improved, and each client benefits from FL and knowledge sharing.

These and other objects and advantages are achieved in accordance with the invention by a method comprising a) providing a global model based on federated learning to at least one client by the server, b) checking by the at least one client whether at least one sensitive model parameter that is not included in the global model is stored in the memory, and if yes, aggregating the provided global model with the at least one sensitive model parameter and updating the global model as a client model, and if no, updating the client model with the provided global model, c) providing at least one reference dataset for operating the technical device, d) calculating a first accuracy of the client model with the aid of the at least one reference dataset, e) determining the gradients of the model parameters of the client model and determining at least one selected gradient of the model parameters of the client model that lies outside of a predefined value range, f) removing the at least one model parameter that is associated with the at least one selected gradient from the client model, g) calculating a second accuracy of the client model from the preceding step with the aid of the at least one reference dataset, h) checking whether the second accuracy lies below the first accuracy, and if yes, specifying the at least one model parameter that is associated with the at least one selected gradient as at least one sensitive parameter and storing said sensitive parameter in the memory, and providing the client model to the server, i) updating the global model with the aid of the provided client model by the server, and j) operating the technical device by the client with the client model and the at least one sensitive parameter from the memory.

With the inventive method, it is possible to take into account individual model parameters locally for a client without the global model providing these model parameters to other clients. Each client can benefit from the selective dissemination of knowledge. In other words, negative knowledge transfer no longer takes place.

Furthermore, the inventive approach is more energy-efficient because only insensitive parameters are sent to the server, and not all of the parameters, thereby saving on communication costs. The protection of privacy is enhanced because parameters that are specific to local data distributions are not returned to the server. The proposed algorithm works for different learning scenarios, such as classification, regression or similar.

In an embodiment of the invention, the second accuracy is stored in the memory of the respective client. This makes it possible to track the evolution of the first and second accuracy over multiple passes through the method and to infer combinations of model parameters therefrom.

In another embodiment of the invention, the predefined value range is specified at least via the normal distribution of multiple gradients in multiple passes through the method. This makes it possible to track the evolution of the first and second accuracy across multiple passes through the method and to respond dynamically to changes.

The objects and advantages in accordance with the invention are also achieved by a client-server system for operating a technical device using a model based on artificial intelligence by a client of a client-server system comprising a server, which provides a global model based on federated learning, and at least two clients, where each client has a processor and a memory, and each client stores a client model for operating a connected technical device, where the client model comprises sensitive model parameters and non-sensitive model parameters, and where the system is configured to perform the method in accordance with the disclosed embodiments of the invention.

The objects and advantages in accordance with the invention are further achieved by a computer program product having machine-readable instructions stored therein which, when they are executed by a client-server system, causes the client-server system to implement the method in accordance with the disclosed embodiments, where the client-server system comprises a server and at least two clients, and where each client has a processor and a memory.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below with reference to an exemplary embodiment depicted in the attached drawings, in which:

FIG. 1 shows an example of the principle of a visual quality inspection system comprising a model based on artificial intelligence;

FIG. 2 shows an exemplary system in accordance with the invention for visual quality inspection; and

FIG. 3 shows an exemplary flowchart of the method in accordance with the invention.

### DETAILED DESCRIPTION OF THE EXEMPLARY EMBODIMENTS

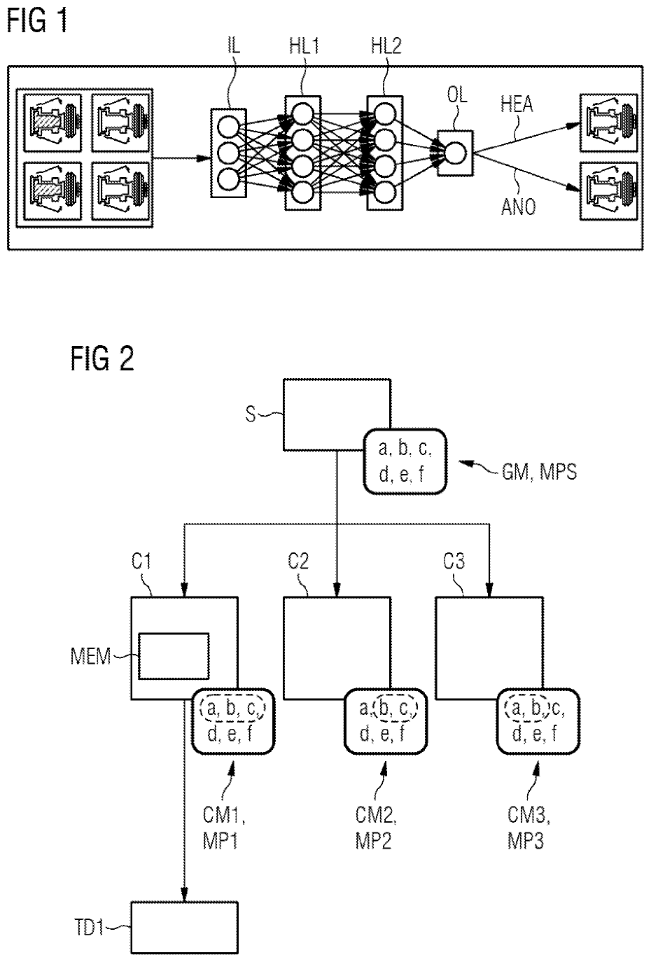

FIG. 1 shows an example of the principle of a visual quality inspection comprising a model based on artificial intelligence in the form of an autoencoder.

An image captured via an optical image sensor is supplied to three input nodes in an input layer IL. Next, an analysis is conducted by several internal, invisible nodes in intermediate layers HL1, HL2 (hidden layers).

An output node in an output layer OL provides an anomaly matrix, which yields either a healthy status HEA or a detected anomaly ANO.

In the context of the instant disclosure, visual quality inspection may also be understood to mean the operation of a technical device when a feedback loop to the production machine is used with the aid of the ascertained quality information, which is not explained in more detail in the following.

Alternatively, the operation of a technical device can be accomplished using a model.

FIG. 2 shows an exemplary system in accordance with the invention for visual quality inspection, comprising a server S and three clients C1, C2, C3 among which ML models are federated. Generally, the system is a client-server system for operating a technical device TD using a model based on artificial intelligence by a client C1 of a client-server system.

The at least one reference dataset for operating the technical device TD1 locally connected to the client C1 can be for, example, a sensor dataset of a camera sensor for a valid operating mode or an error situation and should be chosen so that the specific characteristics of the locally connected device TD1 are mapped to allow one or more sensitive model parameters to be derived from the global model. A dataset for controlling a general connected technical device is also useful.

For the application example of a visual quality inspection for a product produced by a production plant, it is possible to use both the sensor dataset generated during the optical detection of the product via a corresponding sensor and a feedback control dataset for adjusting the control of the production plant of the product in accordance with the determined quality parameters. As a result, it is possible to achieve an automatic optimization of production.

The system comprises the server S having a processor and a server memory, where the server S provides a global model GM on the basis of federated learning.

In the context of the instant disclosure, federated learning is understood to mean the aggregation of personalized models of individual clients by a central server, which in turn makes updated models available to individual clients, for example, when adding new devices with new clients to a system.

Each client C1, C2, C3 taking part in the federated learning has a processor, i.e., a computing device, and a memory MEM. Each client C1, C2, C3 stores a client model CM1, CM2, CM3 for operating its own connected technical device in each case, like client C1 is connected to device TD1.

With the aid of a camera, the quality inspection system captures sensor data of products produced previously by a production system.

The system applies a model comprising a plurality of parameters to acquired sensor data to detect anomalies in the sensor data. Following this, a technical device, such as a production machine, can be actuated to improve characteristics of the production plant. The parameters of clients C1, C2, C3 comprise sensitive parameters that are dependent on input parameters and are determined during the training of the ML model.

An optimization of the ML model, particularly in the case of a neural network, can be realized based on the gradient of the model parameters.

$${θ}^{′} := θ - α {∇}_{θ} ℒ ( {f}_{θ} ; \{ {X}^{train} , {y}^{train} \} )$$

The aim here is to identify the sensitive parameters and to update the federated model, albeit without the sensitive parameters, to obtain a high-quality and generally valid FL model that is shared with other clients.

In addition, sensitive model parameters are added to the local client models to achieve a specific adaptation of the client models.

FIG. 2 shows a set of model parameters MPS comprising model parameters a, b, c, d, e, f on the server S and, for each client C1, C2, C3, a respective set of model parameters MP1, MP2, MP3 comprising respective model parameters a, b, c, d, e, f, each having individual sensitive and non-sensitive parameters.

Server S shows a set of model parameters MPS comprising parameters a, b, c, d, e, f.

Client C1 shows a set of model parameters MP1 comprising sensitive parameters a, b, c and non-sensitive parameters d, e, f.

Client C2 shows a set of model parameters MP2 comprising sensitive parameters b, c and non-sensitive parameters a, d, e, f.

Client C3 shows a set of model parameters MP3 comprising sensitive parameters a, b and non-sensitive parameters c, d, e, f.

The model parameters MP1 of client C1 are different with respect to their sensitive and non-sensitive parameters MP1 from those of client C2 or C3 even though all clients C1, C2, C3 and server S have the same model parameters a, b, c, d, e, f.

Sensitive parameters can be determined based on a gradient determination of the individual model parameters MP1, MP2, MP3. Predetermined value ranges can be resorted to in order to determine a sensitive parameter. The sensitive parameter can be established with the aid of accuracy determination of the model using provided reference data whether a significant deterioration of the client model results compared with the global model, which is an indicator for a sensitive parameter.

Optionally, in addition to a static threshold value or value range, a threshold value or value range can also be defined dynamically, for example, via the following relationship:

$$\begin{matrix}Threshold \_ grad = μ ( {G}_{Θ} ) + 2 σ ( {G}_{Θ} ) \\ where \\ {G}_{Θ} = \{ g r a {d}_{θ} ∀ θ ∈ model \}\end{matrix}$$

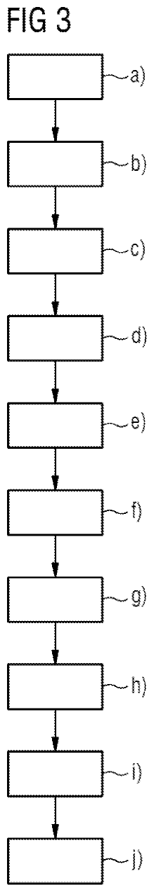

FIG. 3 shows an exemplary flowchart of the method in accordance with the invention.

The method serves for operating a technical device TD1 using a model based on artificial intelligence by a client C1 of a client-server system.

A server S of the system provides a global model GM for operating the technical device TD based on federated learning.

The system comprises at least two clients C1, C2, C3, each client C1, C2, C3 having a processor and a memory MEM.

Each client C1, C2, C3 stores an individual client model CM1, CM2, CM3 for operating a respective connected technical device.

The following acts are performed in accordance with the inventive method: a) provide the global model GM based on federated learning to at least one client C1 by the server S, b) check by the at least one client C1-C3 whether at least one sensitive model parameter that is not included in the global model GM is stored in the memory MEM, and if yes, aggregate the provided global model GM with the at least one sensitive model parameter and update the global model as a client model CM1, and if no, update the client model CM1 with the provided global model GM, c) provide at least one reference dataset for operating the technical device TD1, d) calculate a first accuracy of the client model CM1 with the aid of the at least one reference dataset, e) determine the gradients of the model parameters of the client model CM1 and determine at least one selected gradient of the model parameters of the client model CM1 that lies outside of a predefined value range, f) remove the at least one model parameter associated with the at least one selected gradient from the client model CM1, g) calculate a second accuracy of the client model CM1 from the preceding step with the aid of the at least one reference dataset, h) check whether the second accuracy lies below the first accuracy, and if yes, specify the at least one model parameter associated with the at least one selected gradient as at least one sensitive parameter and store the sensitive parameter in the memory MEM, and provide the client model CM1 to the server S, i) update the global model with the aid of the provided client model CM1 by the server S, and j) operate the technical device TD1 by the client C1 using the client model CM1 and the at least one sensitive parameter from the memory MEM.

The second accuracy can be stored in the memory MEM of the respective client C1, C2, C3. The predefined value range can be specified at least via the normal distribution of multiple gradients in multiple passes through the method. The stored sensitive model parameters can preferably be stored in a list. Initially, the memory for the sensitive model parameters is empty.

As soon as the accuracy of the client model deteriorates, the system identifies sensitive parameters according to the gradients of the model parameters with the aid of a corresponding threshold value or value range for the model parameters.

If the predetermined threshold value is exceeded or if the gradients are located far outside of the predetermined value range, then the corresponding model parameter is identified as a sensitive parameter.

Other sensitive parameters can be available for each client C1-C3, as can be seen in FIG. 2. The clients C1, C2, C3 send only non-sensitive model parameters to the server S for formation of the federated model.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer-implemented method for operating a technical device utilizing a model based on artificial intelligence by a client of a client-server system comprising a server, which provides a global model for operating the technical device based on federated learning, and at least two clients, each client including a processor and a memory, and each client storing a client model for operating a connected technical device, the method comprising:
a) providing, by the server, the global model based on the federated learning to at least one client;
b) checking, by the at least one client, whether at least one sensitive model parameter which is not included in the global model is stored in the memory, and aggregating the provided global model with the at least one sensitive model parameter and updating said global model as a client model if the at least one sensitive model parameter which is not included in the global model is stored in the memory otherwise updating the client model with the provided global model if the at least one sensitive model parameter which is not included in the global model is not stored in the memory;
c) providing at least one reference dataset for operating the technical device;
d) calculating a first accuracy of the client model aided by the at least one reference dataset;
e) determining gradients of model parameters of the client model and determining at least one selected gradient of the model parameters of the client model which lies outside of a predefined value range;
f) removing the at least one model parameter associated with the at least one selected gradient from the client model;
g) calculating a second accuracy of the client model from the preceding step aided by the at least one reference dataset;
h) checking whether the second accuracy lies below the first accuracy, specifying the at least one model parameter associated with the at least one selected gradient as at least one sensitive parameter and storing said sensitive parameter in the memory if the second accuracy lies below the first accuracy, and providing the client model to the server;
i) updating, by the server, the global model aided by the provided client model; and
j) operating, by the client, the technical device utilizing the client model and the at least one sensitive parameter from the memory.

2. The method as claimed in claim 1, wherein the second accuracy is stored in the memory of a respective client.

3. The method as claimed in claim 1, wherein the predefined value range is specified at least via a normal distribution of multiple gradients in multiple passes through the method.

4. A client-server system for operating a technical device utilizing a model based on artificial intelligence by a client of a client-server system comprising a server, which provides a global model based on federated learning, and at least two clients, each client including a processor and a memory, and each client storing a client model for operating a connected technical device, said client model comprising sensitive model parameters and non-sensitive model parameters;
wherein the system is configured to
a) provide the global model based on the federated learning to at least one client;
b) provide at least one reference dataset for operating the technical device;
c) calculate a first accuracy of the client model aided by the at least one reference dataset;
d) determine gradients of model parameters of the client model and determine at least one selected gradient of the model parameters of the client model which lies outside of a predefined value range;
e) remove the at least one model parameter associated with the at least one selected gradient from the client model;
f) calculate a second accuracy of the client model from the preceding step aided by the at least one reference dataset;
g) check whether the second accuracy lies below the first accuracy, specify the at least one model parameter associated with the at least one selected gradient as at least one sensitive parameter and store said sensitive parameter in the memory if the second accuracy lies below the first accuracy, and receive the client model; and
h) update, by the server, the global model aided by the provided client model;
wherein the at least one client checks whether at least one sensitive model parameter which is not included in the global model is stored in the memory, and aggregates the provided global model with the at least one sensitive model parameter and updates said global model as a client model if the at least one sensitive model parameter which is not included in the global model is stored in the memory and otherwise updates the client model with the provided global model if the at least one sensitive model parameter which is not included in the global model is not stored in the memory; and
wherein the client operates the technical device utilizing the client model and the at least one sensitive parameter from the memory.

5. A computer program product having machine-readable instructions stored therein which, when executed by a client-server system, cause the client-server system to perform the method as claimed in claim 1, wherein the client-server system comprises a server and at least two clients, and wherein each client includes a processor and a memory.
